(19) United States
(12) Patent Application Publication
(10) Pub. No.: US 2005/0240571 A1
(43) Pub. Date: Oct. 27, 2005

(54) System and method for automatically gathering information relating to an actor in an environment

(75) Inventors: Karen Z. Haigh, Greenfield, MN (US); Christopher W. Geib, Minneapolis, MN (US); Wende L. Dewing, Minneapolis, MN (US)

Correspondence Address: HONEYWELL INTERNATIONAL INC., 101 COLUMBIA ROAD, P O BOX 2245, MORRISTOWN, NJ, 07962-2245, US

(73) Assignee: Honeywell International Inc.

(21) Appl. No.: 10/830,539

(22) Filed: Apr. 23, 2004

(51) Int. Cl. G06F 7/00

(52) U.S. Cl. 707/3

(57) ABSTRACT

A system and method for automatically gathering information to assist in evaluating an actor in an environment. The method includes monitoring information relating to the actor. The existence of a querying situation is then automatically recognized. The querying situation implicates a mental of physical status of the actor or environment, and is based upon at least one factor apart from a direct request by the actor for assistance. In response to the recognition that a querying situation exists, a query is formulated and then automatically posed. In one embodiment, the query is posed to the actor. In another embodiment, the query is posed to a person having knowledge of the actor's activities. In yet another embodiment, the monitored information is used as the basis for recognizing the existence of a querying situation.

### BACKGROUND

The present invention relates to an automated system and method for gathering information useful in evaluating an actor in an environment. More particularly, it relates to a system and method for generating one or more queries to an actor or someone related to the actor (e.g., the actor's caregiver, supervisor, etc.) under various circumstances recognized as implicating the actor's mental or physical status. Potential domains include in-home monitoring systems, eldercare, and workplace environments (including hazardous work environments) to name but a few.

Evolution of technology has given rise to the implementation of automated systems in a wide variety of environments. Many of these automated systems have the ability to “track” actions of an actor within the environment. For example, automated systems associated with industrial applications oftentimes record operational parameter settings as selected or changed by an actor/operator. Further, devices adapted for in-home environments have more recently incorporated automated features designed to make daily, in-home living more convenient. For example, many in-home appliances (e.g., ovens, microwaves, dishwashers, refrigerators, etc.) have automated control features. These in-home devices may be initially configured to “track” operational control settings or can be converted to do so. Further, regardless of environment, sensor technology has advanced to a level whereby numerous actions (or non-actions) within the actor's environment, or by the actor himself/herself, can be monitored or otherwise “sensed”. These and other advancements have prompted research into the feasibility of a universal environment control system that not only automates operation of various devices within the environment, but also monitors activities of an actor in the environment and performs device control based upon the actor's activities. In other words, it may now be possible to provide coordinated, situation-aware, universal support to an actor in an environment.

Regardless of the complexities associated with a particular automated system installation, the sensed or recorded action may be of interest to a third person otherwise concerned with or evaluating the actor's status and/or decision-making process. For example, in an industrial setting, a plant manager reviewing tracked records of a previous day's operation may notice that an actor/operator changed a temperature control set point on a particular piece of equipment. The plant manager may believe that this change in set point is contrary to normal operating protocols. However, it may be that the actor/operator correctly altered the set point in response to a recent recommendation by the equipment supplier. Without this additional information in hand, the plant manager may negatively view the actor/operator as having made a poor decision.

In-home environments may present a heightened need for actor information. For example, some individuals may have a greater propensity for physical or mental deterioration and/or on-going health concerns, such as elderly individuals. Certain actions (or non-actions) of such an individual may implicate the possible on-set, recurrence, deterioration, or improvement of a certain actor status concern. For example, an actor may be provided with an automated pill-dispensing system that is programmed to remind the actor when it is time to take medication (e.g., audible beeping sound), as well as to record whether medication was dispensed following a reminder (thus implying that the actor did, in fact, take the medication). As a point of reference, an actor's failure to take medication in response to a reminder could be indicative of mental or physical problems. As such, a caregiver may rely upon this “failure to dispense medication in response to a reminder” information during a subsequent assessment of the actor's status. Under certain circumstances, however, the actor may have a good reason for not taking the medication in response to the reminder, for example because the dispenser was empty. Without this additional information, the caregiver may incorrectly conclude, based upon the “failure to dispense” information, that the actor is experiencing health problems (e.g., forgetfulness) that do not otherwise exist.

A plethora of other circumstances in a variety of environments and contexts exist in which additional information from an actor (or others having information relating to the actor) would be useful in evaluating the actor's mental or physical well-being and/or decision-making process. For example, a caregiver may want to know why an actor has abandoned a particular task or goal. Further, a caregiver may wish to gain further information from an actor or another having direct knowledge of the actor's actions upon identifying a symptom of a medical condition or other condition of interest. Also, a supervisor may be interested in learning the reasons behind an actor/operator decision to deviate from a recommended control sequence. It will be understood that these are but a few situations in which additional information from (or about) an actor would be of great value.

Though highly desirable, current automated systems do not have the ability to intelligently query the actor (or others having knowledge of the actor's actions) in situations where additional information regarding the actor would be of value. At best, existing systems employ hard coded stimulus-response mechanisms. With this technique, a specific query is always posed to the actor upon the occurrence of a pre-determined (usually single) action. For example, a computer system can be programmed such that whenever the user presses a certain key or sequence of keys (usually a request by the user for assistance), a query is automatically posed to the user. Oftentimes, the query provides a list of possible “answers” for the user to select from, and does not afford the ability to provide situation-specific information. Moreover, existing hard coded stimulus-response-type mechanisms cannot account for the multitude of situations in which additional actor information would be beneficial, and thus are of minimal value.

Emerging sensing and automation technology represents an exciting opportunity to develop actor monitoring systems with applications to multiple, diverse environments. In this regard, a highly desirable feature associated with such a system is an ability to intelligently decide to issue a query to the actor or another with knowledge of the actor's activities under various circumstances that are not otherwise dictated by a stimulus-response mechanism.

### SUMMARY

One aspect of the present invention relates to a method for automatically gathering information to assist in evaluating an actor in an environment. The method includes monitoring information relating to the actor. The existence of a querying situation is automatically recognized. The querying situation implicates a mental or physical status of the actor or a status of the environment, and is based upon at least one factor apart from a direct request by the actor for assistance. In response to the recognition that a querying situation exists, a query is formulated and then automatically posed. In one embodiment, the query is posed to the actor. In another embodiment, the query is posed to a person having knowledge of the actor's activities. In yet another embodiment, the monitored information is used as the basis for recognizing the existence of a querying situation.

Another aspect of the present invention relates to a system for automatically gathering information to assist in evaluating an actor in an environment. The system includes a controller, least one sensor for monitoring the actor, and at least one user interface. The controller is electronically connected to the sensor and the user interface. Further, the controller is adapted to automatically recognize the existence of a querying situation that otherwise implicates a mental or physical status of the actor or status of the environment. In this regard, the querying situation is based upon at least one factor apart from a direct request by the actor for assistance. The controller is further adapted to formulate a query relating to the querying situation. Finally, the controller is adapted to prompt posing of the query. In one embodiment, the controller is further adapted to utilize the monitored information to determine whether an event relating to the actor is relevant to an evaluation of the actor's mental or physical status or evaluation of the environment's status.

### BRIEF DESCRIPTION OF THE DRAWINGS

FIG. 1 is a block diagram illustrating a system including a query module in accordance with the present invention;

FIG. 2 is a flow diagram illustrating a method of generating information for evaluating an actor in accordance with the present invention;

FIG. 3 is a block diagram of portions of the query module of FIG. 1 in accordance with one embodiment of the present invention; and

FIG. 4 is a block diagram of an in-home monitoring and response system including a query module in accordance with the present invention.

### DETAILED DESCRIPTION

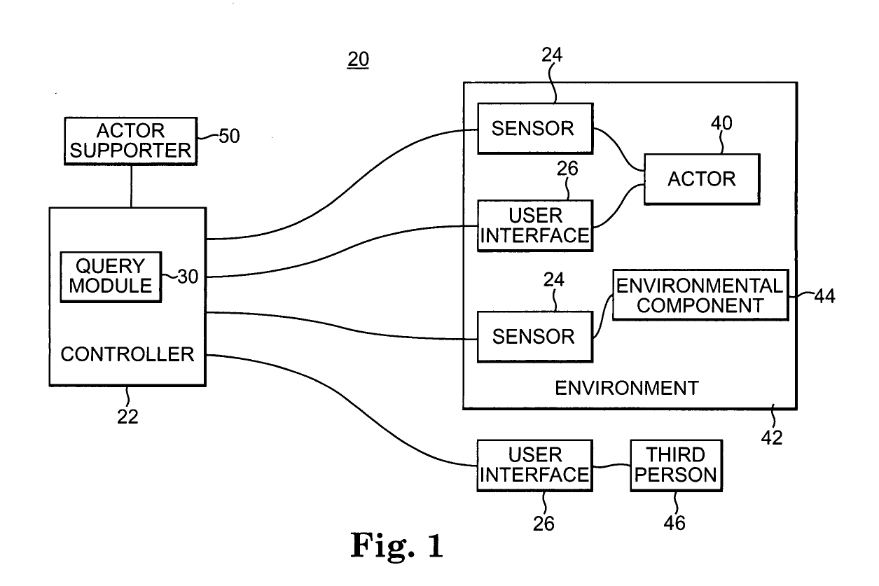

One preferred embodiment of a querying system 20 in accordance with the present invention is shown in block form in FIG. 1. In most general terms, the system 20 includes a controller 22, one or more sensors 24, and one or more actor interface devices 26 (with the sensor(s) 24 and the actor interface device(s) 26 collectively referred to as “data sources”). The controller 22 includes a query module 30 described in greater detail below. The sensor(s) 24 actively, passively, or interactively monitor activities of an actor or user 40 and/or segments of the actor's environment 42 such as one or more specified environmental components 44. Information or data from the sensor(s) 24 is signaled to the controller 22. Similarly, the actor interface device 26 directly interfaces with the actor 40 (or a third person 46 having knowledge of the actor's situation), recording information that the controller 22 and/or the query module 30 have requested from the actor 40 or the third person 46. The so-generated information is signaled to the controller 22 and saved for subsequent review by a person (or “actor supporter”) 50 concerned with or otherwise supporting the actor 40. To this end, the query module 30 determines whether a querying situation exists relative to the actor 40 and, under those circumstances, generates a query and prompts delivery or posing of the query to the actor 40 and/or the third person 46. As used throughout this specification, the phrase “querying situation” relates to the mental or physical status of the actor 40, such as the actor's mental or physical health, thought process, etc. A “querying situation” is one in which a person(s) concerned with the actor 40 (such as the person 50) would be interested in further information to better evaluate the actor's mental or physical status.

The following description of the present invention is with respect to but one acceptable domain of an actor or patient in an in-home or care (e.g., eldercare) daily living environment. Alternatively, the system and method of the present invention are applicable to other domains, such as a work place that may be hazardous (e.g., coal mine, space station, etc.), or less rigorous, in which one or more actors or workers operate. Thus, any environment in which an actor spends a significant amount of time (e.g., two or more hours) on a regular basis can be considered a “daily living environment,” or simply “an environment” of the actor 40 in which the present invention is useful. Similarly, the “third person” 46 can be any person familiar with the actor 40. For example, where the actor 40 is a person in a daily care environment, the third person 46 can be a relative, friend, neighbor, or formal caregiver of the actor 40. Additionally, where the actor 40 is a worker at a place of employment, the third person 46 can be a co-worker.

The key component associated with the system 20 resides in the query module 30 associated with the controller 22. As such, the sensor(s) 24 and the actor interface device(s) 26 can assume a wide variety of forms. Preferably, the sensors 24 are networked by the controller 22. The sensors 24 can be non-intrusive or intrusive, active or passive, wired or wireless, physiological or physical. In short, the sensors 24 can include any type of sensor that provides information relating to activities of the actor 40 or other information relating to the actor's environment 42, including one or more of the environmental component(s) 44. For example, the sensors 24 can include a medication caddy, light level sensors, “smart” refrigerators, water flow sensors, motion detectors, pressure pads, door latch sensors, panic buttons, toilet-flush sensors, microphones, cameras, fall-sensors, door sensors, heart rate monitor sensors, blood pressure monitor sensors, glucose monitor sensors, moisture sensors, telephone sensors, thermal sensors, optical sensors, seismic sensors, etc. In addition, one or more of the sensors 24 can be a sensor or actuator associated with a device or appliance used by the actor 40, such as a stove, oven, television, telephone, security pad, medication dispenser, thermostat, computer interface, etc., with the sensor or actuator providing data indicating that the device or appliance is being operated by the actor 40 (or someone else).

Similarly, the actor interface device(s) 26 can also assume a wide variety of forms. Examples of applicable interface devices 26 include computers, displays, keyboards, web pads, telephones, pagers, speaker systems, etc. In general terms, the actor interface device 26 is configured to interact with the actor 40 (or the third person 46), requesting specific information and recording responses. For example, the actor interface device 26 can be a “standard” personal computer that presents questions to the actor 40 and/or the third person 46 via a display screen and receives answers via a keyboard entry device. Alternatively, or in addition, the actor interface device 26 can be a home audio system operated to audibly interact with the actor 40 and/or the third person 46 and record responses of the actor 40 and/or the third person 46.

The manner and format in which information is provided to the query module 30, as well as the assessment techniques performed thereby, are discussed in greater detail below. Generally speaking, the query module 30 is provided with “raw data” from which the query module 30 can independently determine circumstance(s) of the actor 40. Alternatively, the “raw data” can first be reviewed and quantified by one or more other components/modules of the controller 22, with the resultant “information” being provided to be query module 30 in the form of a conclusion (e.g., “the actor is eating lunch”). With this in mind, the query module 30 is adapted to evaluate information in a wide variety of contexts, determining that a querying situation exists based upon an intelligent review of, in a preferred embodiment, multiple circumstances that do not otherwise lend themselves to a stimulus-response rule. That is to say, the query module 30 is characterized by determining or recognizing the existence of a querying situation based upon at least one factor apart from a direct request by the actor 40 for assistance, a situation that would otherwise be akin to a stimulus-response mechanism. The query module 30 is capable of reviewing a sensed situation relating to the actor 40, determining that the current situation may be of interest to a person concerned with the actor 40, and further determining that additional information from the actor 40 (and/or the third person 46) relating to the situation could augment the reviewing person's 50 evaluation of the actor 40 relative to the situation. In this context, then, the query module 30 evaluates the sensed situation before determining that a querying situation exists, rather than simply automatically delivering a query in response to one specific action by the actor 40. Of course, the query module 30 can be programmed to include a stimulus-response mechanism (e.g., a query is issued to the actor 40 every time the actor 40 presses a “help” key on the interface device 26); however, the query module 30 is capable of recognizing the existence of a querying situation without the assistance of a stimulus-response mechanism.

For example, the query modules 30 can be provided with (or independently determine) information indicating that the actor 40 was presented with a warning prompt to change a set point of a certain device controller associated with a machinery operation system, and further that ten minutes after the warning prompt was delivered, the control setting had not yet been changed. From this information, the query module 30 can determine (or can be conclusively informed) that the actor 40 has ignored the warning prompt, and that the actor's 40 supervisor may wish to know why the actor 40 decided to ignore the warning prompt in light of perceived importance of this control setting. Under these circumstances, then, the query module 30 would determine that a querying situation exists, then generating and prompting delivery of an appropriate query. Alternatively, the recognition of a querying situation can be more complex. For example, the query module 30 can be provided with information indicating that the actor 40 is engaged in a certain task (the query module 30 can independently infer or conclude that the actor 40 is engaged in the task or the information presented to the query module 30 can be in the form of a conclusionary determination that the task has been initiated), and that the actor 40 has later abandoned this task prior to completion. Under these circumstances, the query module 30 can determine that the actor's 40 apparent decision to abandon the task is potentially indicative of mental and/or physical issues that the actor supporter 50 concerned with the actor 40 might otherwise consider relevant in evaluating the actor's 40 status. Because this task abandonment could be used as the basis for evaluating the actor 40, the query module 30 determines that additional information from the actor 40 (or the third person 46 familiar with the actor 40) would perhaps better explain the situation, and thus, that a querying situation exists.

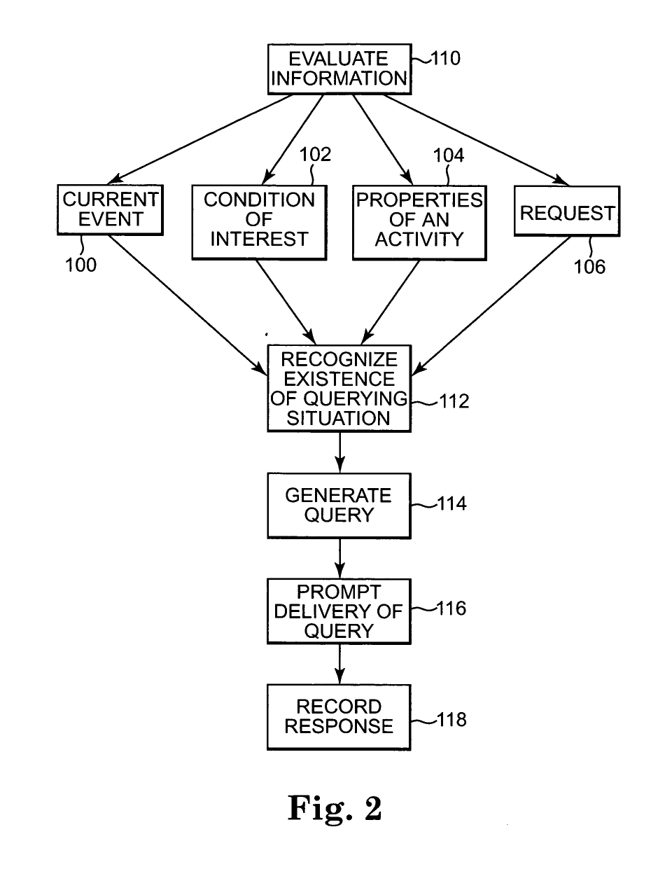

The above examples are but two of a virtually endless listing of possible circumstances under which the query module 30 will determine or recognize that a querying situation exists. With this in mind, FIG. 2 diagrammatically illustrates example subject matter categories or topics under which the query module 30 may, in one embodiment of the present invention, determine the existence of a querying situation. In particular, these topics include current events 100, conditions of interest 102, properties of an activity 104, and requests 106. Relative to functioning of the query module 30, information is first evaluated (shown in FIG. 2 as step 110). With the one embodiment of FIG. 2, the information being reviewed may correspond with one of the categories 100-106; if so, the query module 30 evaluates the information in the context of the particular topic, and, where appropriate, independently decides or recognizes at step 112 that a querying situation exists. Subsequently, at step 114, a query is generated. The query is then posed to the actor 40 (FIG. 1) and/or the third person 46 (FIG. 1) with knowledge of the actor at step 116. Finally, the response to the query is recorded at step 118.

Relative to the current event 100 category, and with additional reference to FIG. 1, the query module 30 can evaluate and determine the existence of a querying situation in a number of different contexts. In one embodiment, the current event 100 category includes the actor's 40 actions, the actor's 40 activities, the actor's 40 goals/tasks, reminders given to the actor 40, and/or events in the environment 42 (e.g., door opening, window breaking, smoke detector, etc.). For example, the query module 30 can recognize a querying situation upon learning/determining that the actor 40 is performing an unexpected action (e.g., the actor flushes his/her toilet five times in succession). Conversely, the query module 30 can learn/determine that the actor 40 is expected to perform a certain action, and recognize that failure of the actor 40 to do so constitutes a querying situation (e.g., the actor 40 fails to answer a ringing telephone). As used throughout this specification, the phrases “learning/determining” and “learn/determine” are in reference to the query module 30 being provided with conclusionary information from another system module (e.g., another module informs the query module 30 that “the actor has flushed the toilet five times”) or the query module 30 reviewing “raw” data and independently concluding that a particular action or non-action has occurred (e.g., the query module 30 reviews sensor data of the phone ringing, the actor 40 being present in the environment 42, and the phone receiver is not picked up, and concludes that the actor 40 has failed to answer the phone). Once again, the present invention encompasses either or both query module configurations.

The query module 30 can further be provided with the capability of determining the existence of a querying situation in light of activities or non-activities of the actor 40. To this end, an “activity” can be defined as a grouping of individual actions relating to a common subject. For example, playing the piano, eating a meal, operating a machine, etc., are all examples of “activities”. With this in mind, the query module 30 can learn/determine that the actor 40 is engaged in an unexpected activity and designate this event as a querying situation. For example, the query module 30 can recognize a situation in which the actor 40 is found to be bathing late at night when the actor 40 normally bathes in the morning as a querying situation. Conversely, a querying situation can be recognized by the query module 30 where it is learned/determined that the actor 40 has failed to engage in an expected activity. For example, the query module 30 can learn/determine that the actor 40 normally watches a television news program at 6:00 p.m. on weekdays. Under these circumstances, where the query module 30 learns/determines on a particular weekday that the actor is not watching television at 6:00 p.m., a querying situation can be declared.

The query module 30 can similarly recognize that the actor's 40 engagement in and/or completion of a task or goal is relevant to an evaluation of the actor's 40 mental and/or physical status, and thus that a querying situation exists. Tasks are akin to “activities” previously described, but have an end goal or result that is achieved by the performance of various identifiable steps. Programming a VCR, preparing a meal, washing clothes, etc., are all examples of “tasks”. With this in mind, the query module 30 can learn/determine that the actor 40 is engaging in a particular task that is otherwise relevant to an evaluation of the actor's mental or physical status to recognize existence of a querying situation. For example, learning/determining that the actor 40 is attempting to perform a relatively dangerous task (e.g., repairing a non-operating garbage disposal) can give rise to a querying situation. Further, for certain actors, the fact that the actor 40 has completed a task can be designated as a querying situation. For example, where a mentally impaired actor who previously experienced difficulties in completing certain tasks, such as making a meal, successfully completes the task on one occasion, the query module 30 can determine that a caregiver would gain insight into learning circumstances surrounding the actor's successful completion of the task (e.g., “did the actor have assistance?”), and thus, that a querying situation exists. Conversely, the query module 30 can determine that a querying situation exists when the actor 40 abandons a task prior to completion. For example, an elderly actor who normally is able to take his/her dog for a walk, but on one occasion is found to have abandoned the dog-walking task prior to completion, may signify physical problems; under these circumstances, the querying module 30 can recognize the existence of a querying situation.

Yet another current event 100 topic relates to the actor's 40 response to a reminder to do something. For example, an audible and/or visual reminder may be issued to the actor 40 in an effort to prompt the actor 40 to take certain medication. Under circumstances where the actor 40 does not respond to this reminder (thus giving rise to a conclusion that the actor 40 did not take the medication), the query module 30 can determine that a querying situation exists as the actor's 40 failure to respond to the reminder is likely relevant to an evaluation of the actor's 40 mental or physical status.

In addition or as an alternative to the current event 100 subject matter described above, the query module 30, in a preferred embodiment, can recognize the existence of a querying situation upon learning/determining that a symptom of a condition of interest (102 in FIG. 2) has been identified. In essence, the query module 30 can recognize a querying situation based upon a functional ability assessment of the actor 40. In general terms, the functional ability assessment relates to the actor's physical and/or mental capabilities, and can include medical conditions. In many circumstances, certain conditions of interest can be implicated by identifiable actions or physical characteristics (collectively referred to as “symptoms”). For example, the on-set or recent occurrence of a stroke (i.e., a condition of interest) is characterized by changes in the actor's 40 gait, voice, confusion, etc. Certain classes of actors can be viewed as being susceptible to one or more conditions of interest such that upon occurrence of a related symptom, the query module 30 will recognize the existence of a querying situation in that a person concerned for the actor 40 (e.g., a caregiver) will likely view the symptom as being relevant to an evaluation of the actor's 40 mental or physical status. For example, a certain actor may be viewed as being susceptible to alcohol abuse. Upon learning/determining that a related symptom has been sensed (e.g., slurred speech, irregular sleep patterns, etc.), the query module 30 will determine that a condition of interest is implicated and can then recognize that a querying situation exists. Functional ability or conditions of interest are described in greater detail in U.S. patent application Ser. No. 10/703,709, filed Nov. 6, 2003, the teachings of which are incorporated herein by reference.

Yet another category of information under which the query module 30 of the present invention can determine the existence of a querying situation relates to the properties of an activity 104. As previously described, certain activities (or lack thereof) of the actor 40 can, in and of themselves, implicate a querying situation. Alternatively, changes in the property or properties of a particular activity can also be relevant to a mental or physical status evaluation of the actor 40. For example, the actor 40 may consistently be able ascend the same flight of stairs in the environment 42 on a daily basis. Over time, however, it may take the actor 40 longer to perform this same activity. Under these circumstances, this change may be indicative of a deterioration of the actor's 40 physical abilities, such that a querying situation could be recognized by the query module 30. Similarly, a one-time deviation from a “normal” property of an activity can be relevant to the mental or physical status of the actor 40. For example, over time, it can be learned that the actor 40 normally takes 30-45 seconds to ascend a flight of stairs. Upon determining that while successful, the actor's 40 most recent attempt at ascending this same flight of stairs took two minutes, the query module 30 could recognize this activity property as implicating a mental or physical concern. Once again, the query module 30 could then recognize the existence of a querying situation to provide better context to this activity property deviation for subsequent evaluation by the actor supporter 50 who is otherwise concerned with the actor's 40 well being. With this in mind, the query module 30 can be adapted to review/analyze a variety of different properties for a variety of different activities. Exemplary properties include activity duration, time of day in which the activity was performed, number of distractions, number of prompts required to the actor 40 for performing the activity, etc.

Yet another category of information under which the query module 30 can recognize the existence of a querying situation is the request (106 in FIG. 2) by a person other than the actor 40 that a query be posed (i.e., the “actor supporter” 50 in FIG. 1). In one embodiment, the request or prompt for posing of a query is directly made by the actor supporter 50 (e.g., the actor's caregiver, supervisor, etc.). In an alternative embodiment, the query module 30 is adapted to interpret less-specific instructions from the actor supporter 50 as giving rise to a querying situation. For example, the query module 30 can learn/determine that the caregiver 50 recommends a glucose test be performed every four hours. Under these circumstances, the query module 30 can determine that this request is directly related to a health concern and thus will decide at the time of each glucose test that a query be posed to the actor 40.

System and Environment Examples

The system 20 can assume a wide variety of forms that provide the query module 30 with the ability to recognize the existence of a querying situation in one or more of the described circumstances. The manner in which the query module 30 receives information from the various sensor(s) 24 and/or the actor interface device(s) 26 as well as the format of that information (i.e., whether the query module 30 receives raw data directly from the sensors and devices 24, 26 or if the raw data is first processed by one or more other system modules that analyze, either alone or in combination, the sensor and/or interface device data and present analyzed information and/or conclusions to the query module 30) is a function of the overall system 20 configuration relative to the actor 40 and the actor's environment 42, and in particular the controller 22 architecture. The controller 22 is preferably a microprocessor-based device capable of storing and operating preferred modules, including the query module 30. The components of the present invention can be implemented in hardware via a microprocessor, programmable logic, or state machine, in firmware, or in software with a given device.

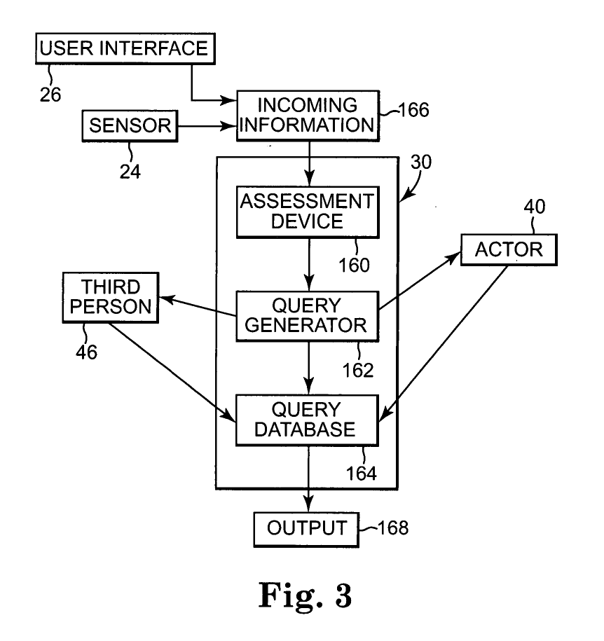

Depending upon the complexity of the particular installation, the controller 22 can include and operate a number of additional modules, the relationships of which relative to the query module 30 are described in greater detail below. In general terms, however, and with additional reference to FIG. 3, the query module 30 includes or provides, in one embodiment, an assessment device 160, a query generator 162, and a query response database 164. The assessment device 160 receives information/data (shown generally in FIG. 3 at 166) from the sensor(s) 24, the interface device(s) 26 (FIG. 1) and/or one or more other modules as described below via an appropriate interface or link. Regardless, the assessment device 160 reviews the received information 166 and determines whether a querying situation exists. When a querying situation is recognized, the query generator 162 creates an appropriate query relating to the querying situation and/or retrieves a pre-written query applicable to the querying situation from a database (not shown). Alternatively, the query generator 162 identifies relevant information for a desired query, with this relevant information being formulated into the query by a separate system module or component. The query generator 162 (or other module otherwise receiving the relevant query information from the query generator 162) delivers, or prompts the delivery of, the query to the actor 40 or the third person 46 having knowledge of the actor's activities. For example, the query can be delivered to the actor 40 via the interface device 26, with the query module 30 directly or indirectly communicating with the interface device 26. Regardless, the actor's 40 or the third person's 46 response to this query is recorded in the query response database 164. The stored response(s) is provided to the caregiver or other person 50 concerned with the actor 40 when requested and/or provided to other system module(s) for use in subsequent analyses (referenced generally as “output” at 168).

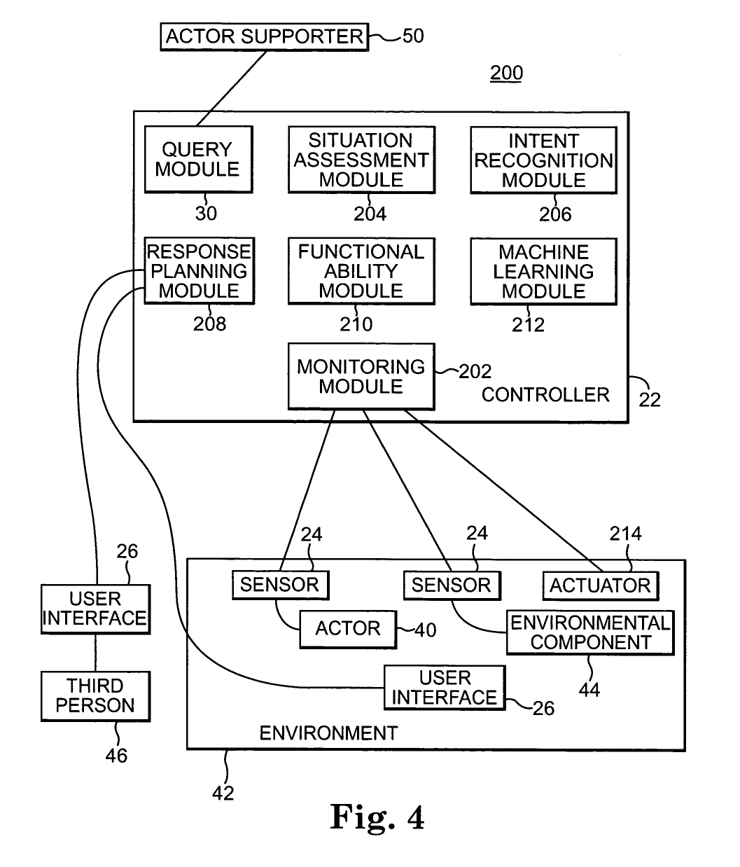

In one preferred embodiment, the system of the present invention is provided as part of an in-home, automated monitoring and response system 200 shown in block form in FIG. 4. Configuration and operation of the monitoring and response system 200 is described in greater detail in U.S. patent application Ser. No. 10/341,355, filed Jan. 10, 2003 and entitled “System and Method for Automated Monitoring, Recognizing, Supporting, and Responding to the Behavior of an Actor”, the teachings of which are incorporated herein by reference. In general terms, the system 200 includes the controller 22 that provides the query module 30 along with other modules such as a monitoring module 202, a situation assessment module 204, an intent recognition module 206, a response planning module 208, a functional ability module 210, and a machine learning module 212. The provided sensor(s) 24 and the actor interface device(s) 26 actively, passively, or interactively monitor activities of the actor 40 as well as segments of the actor's environment 42. Information or data from the sensor(s) 24 and interface device(s) 26 is signaled to the controller 22 for interpretation by the monitoring module 202. The situation assessment module 204 processes information from the monitoring module 202 to determine what the actor 40 is doing, along with what is happening in the actor's environment 42. The intent recognition module 206 functions to determine what the actor 40 is intending to do. Based upon information from the situation assessment module 204 and the intent recognition module 206, the response planning module 208 generates appropriate responses that are carried out by actuator(s) 214 (it being understood that the interface device 26 can be characterized as either a sensor or an actuator). In this regard, the preferred machine learning module 212 “optimizes” operation of the situation assessment module 204, the intent recognition module 206, and the response planning module 208 based upon automatically generated learned models of behavior formulated from information provided by the sensor(s) 24 and/or the interface device(s) 26. One example of an acceptable machine learning module is described in U.S. patent application Ser. No. 10/339,941, filed Jan. 10, 2003, the teachings of which are incorporated herein by reference. Other modules, such as the functional ability module 210, are provided to augment capabilities of the system 200. It will be understood that the system 200 of FIG. 4 is but one acceptable configuration, and that one or more of the modules 202-212 can be eliminated and/or other modules added.

As part of the above operations, the query module 30 receives information directly from the monitoring module 202 or indirectly via one or more of the situation assessment module 204, the intent recognition module 206, the functional ability 210, and the machine learning module 212. In this regard, the query module 30 can be provided as part of one or more of the other modules 204-212, for example as part of the situation assessment module 204. With additional reference to FIG. 2, then, the modules 202-212 assist the query module 30 in intelligently recognizing the existence of a querying situation in one or more of the categories 102-106, or under other circumstances provided for in the query module 30. For example, relative to the current event 100 category, the monitoring module 202 can signal sensor 24/interface device 26 data otherwise indicative of an action by the actor 40 directly to the query module 30. In one embodiment, all sensor 24/interface device 26 information is signaled to the query module 30 that in turn is adapted to extract or parse information known to be indicative of an “action”. Alternatively, the monitoring module 202 can be adapted to review the sensor 24/interface device 26 information and determine the occurrence of an “action”, with this action-specific information or conclusion then being provided to the query module 30. The determination of whether an unexpected action has occurred or whether an expected action has not occurred can be obtained by reference to action parameters stored within a database (not shown) maintained by the query module 30 (or other module(s)), by reference to the machine learning module 210, or both. For example, the machine learning module 212 may indicate that the actor 40 normally flushes the toilet once; where the query module 30 learns/determines that the actor 40 has just flushed the toilet five times in succession, the query module 30 may recognize that a querying situation exists based upon reference to the “normal” one flush information provided by the machine learning module 212.

The situation assessment module 204 is similarly capable of evaluating information from the monitoring module 202 and determining whether the actor 40 is engaged in a particular activity. This activity information is then provided to the query module 30 for evaluation as to whether the activity gives rise to a querying situation as previously described. Alternatively, the query module 30 can, based upon reference to the machine learning module 212, determine that the actor 40 is expected to be engaged in a particular activity; where the situation assessment module 204 otherwise indicates that the actor 40 is not engaged in the expected activity, the query module 30 can then evaluate as to whether these circumstances give rise to a querying situation.

The situation assessment module 204 can further be provided with the capability of recognizing, based upon information from the monitoring module 202, when the actor 40 is engaged in a particular task with reference to information provided by the intent recognition module 206. In general terms, the situation assessment module 204 concludes that the actor 40 is engaging in a particular task or has a particular goal based upon currently sensed actions of the actor 40 and/or events in the environment 42. One acceptable system and method for accomplishing this task/goal recognition is provided in U.S. patent application Ser. No. 10/444,514, filed May 23, 2003, the teachings of which are incorporated herein by reference. In one preferred embodiment, the intent recognition module 206 assists or performs the task or goal recognition operation. In general terms, the intent recognition module 206 incorporates simple hierarchical (task decomposition) plans, and references information in a plan library (not shown), observed actions, and, in a preferred embodiment, hypothesized unobserved actions to recognize or evaluate the likelihood that the actor 40 is engaged in a particular task otherwise described in the plan library. The preferred capability of probabilistically recognizing a task or goal of the actor 40 in a manner that accounts for the possible occurrence or execution of unobserved actions can be accomplished in a variety of fashions, one embodiment of which is described in U.S. patent application Ser. No. 10/286,398, filed Nov. 1, 2002, the teachings of which are incorporated herein by reference. Regardless, the query module 30 is informed that the actor 40 is engaged in a particular task or has a certain goal. As previously described, the query module 30 may evaluate these circumstances as giving rise to a querying situation. Alternatively, or in addition, the querying module 30 will track the actor's 40 progress in completing the task or achieving the goal. This tracking information can be provided directly to the query module 30 via the monitoring module 202 and/or via the situation assessment module 204 that can otherwise correlate information from the monitoring module 202 relative to the identified task or goal, properly categorizing information from the monitoring module 202 as indicating that a particular “step” of the task or goal is being attempted or has been completed by the actor 40. Regardless, the query module 30 is given information indicative of the actor's 40 progress, such that the query module 30 can evaluate the actor's 40 progress (or lack thereof) as possibly giving rise to a querying situation. Finally, the situation assessment module 204 is capable of determining, based upon information from the monitoring module 202, when the actor 40 has completed the task or accomplished the goal. This information is provided to the query module 30 that in turn may recognize the existence of a querying situation based upon an evaluation of the information.

With the one embodiment of FIG. 4, the response planning module 208 is adapted to provide reminders to the actor 40 under a variety of circumstances. For example, the situation assessment module 204 may prompt the response planning module 208 to issue a reminder at predetermined times and/or periodically when warranted by a particular, assessed situation. Regardless, in one preferred embodiment, the query module 30 is informed of any issued reminders. The query module 30 is further informed of when, how, or if the actor 40 responds to this reminder, either directly via interpretation of information provided by the monitoring module 202 or indirectly via the situation assessment module 204 that otherwise processes information from the monitoring module 202. As previously described, the query module 30 can then evaluate the actor's 40 response to the reminder to determine or recognize the existence of a querying situation.

The functional ability module 210 can provide the information necessary for the query module 30 to evaluate whether a determined condition of interest (102 in FIG. 2) gives rise to a querying situation. In general terms, the functional ability module 210 gathers functional ability and/or medical condition data relating to the actor 40 from the monitoring module 202, assesses the gathered data, and provides the assessment to the query module 30. For example, the functional ability module 210 can accumulate and categorize information from the monitoring module 202 within two or more base line categories that in turn facilitate an understanding or evaluation of the actor's 40 overall functional health. Even further, the functional ability module 210 can be adapted to specifically watch for a priori symptoms of certain conditions, such as medical conditions. One example of an acceptable functional ability module is provided in U.S. patent application Ser. No. 10/703,097, filed Nov. 6, 2003. Regardless, information from the functional ability module 210 is provided to the query module 30 that in turn evaluates the information to determine whether the information implicates the existence of a querying situation.

Relative to the properties of an activity 104 category, the query module 30 can categorize and store long-term data relating to specified activity properties. Alternatively, the query module 30 can reference one or more databases maintained by other modules (such as the situation assessment module 204 and the machine learning module 212) that otherwise relate to a property of an activity (e.g., activity duration, time of day, number of distractions, number of prompts required before the actor 40 performs an activity, etc.). Regardless, when a current, corresponding activity property information is provided to the query module 30 (such as via the monitoring module 202 and/or the situation assessment module 204), the query module 30 can compare the current activity property with the previous activity property data, and use this comparison as the basis for recognizing the existence of a querying situation.

Finally, as shown in FIG. 4, the third party requester or actor supporter 50 can directly or indirectly prompt the query module 30 to recognize the existence of a querying situation. Conversely, response information stored by the query module 30 can be provided to the actor supporter 50 when requested or at pre-determined times. The so-provided information can include all responses stored by the query module 30 in raw form. Alternatively, the stored information can be provided to the actor supporter 50 with additional information that correlates the response(s) to a particular event that otherwise gave rise to the decision to pose the query that resulted in the stored response. For example, the query database 164 (FIG. 3) can include sub-directories that store all responses related to a certain subject matter. The actor supporter 50 can then be provided with stored responses from only the subject/sub-directories of interest. Additionally, the response information stored by the query 30 can be provided to one or more of the other modules 204-212 for subsequent analyses (e.g., the intent recognition module 206 may better evaluate an intended goal of the actor 40 based upon actor response information provided by the query module 30).

It will be understood that the above system 200 is but one example of an acceptable configuration that otherwise facilitates automatic recognition of a querying situation by the query module 30. Further, the listed circumstances under which the query module 30 might declare that a querying situation exists is not limited to the above examples.

Regardless of the circumstances under which the query module 30 recognizes the existence of a querying situation, the query module 30 then generates an appropriate query for presentation to the actor 40 or the third person 46 having knowledge of the actor's 40 situation. In one embodiment, the query module 30 initiates the issuance of a query by providing the response planning module 208 with necessary information relating to the desired query. The query module 30 can, in one embodiment, generate the exact query format and decide upon the preferred mode of presentation to the actor 40/third person 46. Alternatively, the response planning module 208 can generate the query based upon information from the query module 30, as well as decide upon who should receive the query, the device through which the query will be presented, and the timing of the query. For example, the query module 30 or the response planning module 208 can determine under circumstances where the actor 40 has unexpectedly left the environment 42, that the actor's daughter (i.e., the third person 46) is the most appropriate person to query as to why the actor 40 left. Regardless, the query can be presented to the actor 40/third person 46 in a multitude of ways including, for example, via an audio component (e.g., telephone or speaker system), visual component (e.g., personal computer display screen, television, etc.), or both. Further, based upon information from the machine learning module 212, the response planning module 208 and/or the query module 30 can determine an optimal format for the query most likely to prompt a response from the actor 40/third person 46 (e.g., the machine learning module 212 may indicate that the actor 40 is most likely to respond to a query consisting of only a few words). Finally, information from the machine learning module 212 can be relied upon by the query module 30 and/or the response planning module 208 to determine a preferred time of day for delivering the query to the actor 40/third person 46.

The system and method of the present invention provides a marked improvement over previous designs. In particular, the system and method is capable of intelligently querying an actor and/or a third person having knowledge of the actor's situation to obtain information that is otherwise useful for evaluating a mental or physical status of the actor. Unlike a stimulus-response mechanism, the system and method of the present invention can determine the desirability for obtaining additional information under a wide variety of dissimilar circumstances that may or may not be “triggered” by a single action by the actor.

Although the present invention has been described with reference to preferred embodiments, workers skilled in the art will recognize that changes can be made in form and detail without departing from the spirit and scope of the present invention.

1. A method for automatically gathering information to assist in evaluating an actor in an environment, the method comprising:
monitoring information relating to the actor;
automatically recognizing existence of a querying situation implicating a mental or physical status of the actor or status of the environment, wherein the recognition is based upon at least one factor apart from a direct request by the actor for assistance;
formulating a query relating to the querying situation; and
automatically posing the query to the actor or another person.

2. The method of claim 1, wherein recognizing existence of a querying situation is based upon the monitored information.

3. The method of claim 2, wherein recognizing the existence of a querying situation includes:
determining whether an event relating to the actor is relevant to an evaluation of the actor's mental or physical status or status of the environment; and
designating that a querying situation exists when it is determined that the event is relevant to an evaluation of the actor's mental or physical status or environment status.

4. The method of claim 3, wherein the method is characterized by not indiscriminately designating that a querying situation exists in response to the event without first evaluating relevance of the event to a mental, physical, or environment status evaluation.

5. The method of claim 3, wherein the method is characterized by the absence of a stimulus-response mechanism.

6. The method of claim 3, wherein the event is the actor performing an unexpected action.

7. The method of claim 3, wherein the event is the actor failing to perform an expected action.

8. The method of claim 3, wherein the event is the actor engaging in an unexpected activity.

9. The method of claim 3, wherein the event is the actor failing to engage in an expected activity.

10. The method of claim 3, wherein the event is the actor engaging in a task.

11. The method of claim 10, further comprising:
determining that the actor is engaging in a task based upon the monitored information; and
monitoring progress of the actor in completing the task.

12. The method of claim 10, wherein the event is the actor completing the task.

13. The method of claim 10, wherein the event is the actor abandoning the task prior to completing the task.

14. The method of claim 3, wherein the event is the actor ignoring a reminder.

15. The method of claim 14, further comprising:
automatically issuing a reminder to the actor; and
monitoring a response of the actor to the reminder.

16. The method of claim 1, further comprising:
assessing a situation of the actor based upon the monitored information;
wherein recognizing existence of a querying situation is based upon the situation assessment.

17. The method of claim 1, wherein recognizing existence of a querying situation includes identifying a symptom of a condition of interest based upon the monitored information.

18. The method of claim 1, wherein recognizing existence of a querying situation includes evaluating a property of an activity.

19. The method of claim 18, wherein evaluating a property of an activity includes comparing a current activity property with previous activity property data.

20. The method of claim 1, wherein recognizing existence of a querying situation includes receiving a prompt from a person other than the actor.

21. The method of claim 1, further comprising:
recording a response to the posed query.

22. The method of claim 19, further comprising:
providing the recorded response to a person concerned with a well being of the actor.

23. The method of claim 1, wherein posing the query includes:
delivering the query via at least one automated medium.

24. The method of claim 23, wherein the automated medium includes at least one of an audio and visual component.

25. The method of claim 1, wherein a plurality of queries are formulated relating to the querying situation.

26. The method of claim 1, wherein a plurality of sensors are provided in the environment, and further wherein monitoring the actor includes processing the data signaled by the sensors.

27. The method of claim 26, wherein recognizing existence of a querying situation includes evaluating information provided by at least two of the sensors.

28. The method of claim 1, further comprising:
deciding whether the query should be posed to the actor or to another person other than the actor.

29. A system for automatically gathering information to assist in evaluating an actor in an environment, the system comprising:
at least one sensor for monitoring the actor;
at least one user interface; and
a controller electronically connected to the sensor and the user interface, the controller being adapted to:
automatically recognize existence of a querying situation implicating a mental or physical status of the actor or status of the environment based upon at least one factor apart from a direct request by the actor for assistance,
formulate a query relating to the querying situation,
prompt the user interface to pose the query, and
record a response to the posed query.

30. The system of claim 29, wherein the controller includes a query module adapted to recognize existence of a querying situation.

31. The system of claim 30, wherein the controller further includes a monitoring module and a situation assessment module linked to the query module.

32. The system of claim 29, wherein the controller is adapted to recognize existence of a querying situation based upon on event relating to the actor.

33. The system of claim 29, wherein the controller is adapted to recognize existence of a querying situation based upon an identified condition of interest.

34. The system of claim 29, wherein the controller is adapted to recognize existence of a querying situation based upon an evaluation of a property of an activity.

35. The system of claim 29, wherein the controller is adapted to decide as to whether the query should be posed to the actor or another person other than the actor.

36. The system of claim 29, wherein the controller is adapted to recognize existence of a querying situation apart from a hard coded, stimulus-response mechanism.

37. The system of claim 29, further comprising a plurality of sensors electronically connected to the controller.
